(19) United States
(12) Patent Application Publication
(10) Pub. No.: US 2005/0021353 A1
(43) Pub. Date: Jan. 27, 2005

(54) DONATION SYSTEM AND METHOD

(75) Inventors: Karen Aviles, Valley Stream, NY (US); Mary Ellen Craig, Northport, NY (US); Jason D. Halpern, New York, NY (US); Wendy W. Lee, New York, NY (US); Anna Mariella, Brooklyn, NY (US); Anne O'Malley, Maplewood, NJ (US); Barbara Reveron-Lens, Yonkers, NY (US)

Correspondence Address: SNELL & WILMER;ONE ARIZONA CENTER, 400 EAST VAN BUREN, PHOENIX, AZ, 850040001, US

(73) Assignee: AMERICAN EXPRESS TRAVEL RELATED SERVICES COMPANY, INC., New York, NY (US)

(21) Appl. No.: 10/707,715

(22) Filed: Jan. 6, 2004

Related U.S. Application Data
(60) Provisional application No. 60/490,205, filed on Jul. 25, 2003.

(51) Int. Cl. G06F 17/60

(52) U.S. Cl. 705/1

(57) ABSTRACT

The present invention includes an automatic bill payment enrollment system for recurring donations, which allows donors to automatically charge charitable donations on a recurring basis to a financial account. In one embodiment, the invention uses a donation portal having various webpages to allow a donor to donate to all U.S. 501(c)(3) organizations. In an alternative embodiment, a donor may donate to any other desired organizations. The system may also incorporate a filter for restricting monies being sent to terrorist organizations. The invention also includes a loyalty point system, wherein loyalty points may be donated to a charity. In another exemplary embodiment, the invention also facilitates employee gift matching.

### CROSS REFERENCE TO RELATED APPLICATIONS

This application claims priority to, and the benefit of, U.S. Provisional Patent Application entitled “Donation System and Method” filed on Jul. 25, 2003, by inventors Karen Aviles, Mary Ellen Craig, Jason D. Halpern, Wendy W. Lee, Anna Mariella, Anne O'Malley, and Barbara Reveron-Lens and assigned U.S. Ser. No. 60/490,205, the entire contents of which is hereby incorporated by reference.

### FIELD OF INVENTION

This application generally relates to charitable donations, and more particularly, to an improved system and method for facilitating online donations to various charities.

### BACKGROUND OF INVENTION

Many charities operate websites that allow a donor to access information about a specific charity and to donate money to the specific charity online. A few charity websites also allow the donor to enter recurring billing information, so that a financial account of the donor is automatically billed on a recurring basis (e.g., monthly). Other charity websites allow the donor to donate value other than money (e.g., stocks) to the charity.

Charities may also allow a donor to donate loyalty points (e.g., frequent flier miles) to the charity. However, these loyalty point donation programs typically involve negotiating and maintaining a relationship between the issuer of the loyalty points and the charity. Further, the loyalty point donation process is often implemented offline such that the donor must print and complete a form from the issuer of the loyalty points (e.g., the airline) and then mail the form to the charity.

Gift matching is another method that is available to users that desire to donate to certain charities. Gift matching usually includes a donor donating money (e.g., $100) to a charity, then the user's employer matching that gift by donating another $100 to the same charity. While many employers provide for gift matching, the process almost always occurs offline because many employers implement different policies and require the completion of different forms regarding the desired charities for gift matching. Thus, if a donor desires that his employer provides a gift match, the donor must obtain an employer-specific gift matching form from the human resources department of the user's company, complete the form and mail that form to the charity to obtain a certification from the charity of the donor donation. If a donor donates online, there may be a large lag time between the time of the employee donation and the charity's receipt of the gift matching form. This lag time may make it difficult for the charity to certify the donation, because the paperwork associated with the donation and/or the gift matching may be difficult to maintain. Further, because the gift matching process often requires the donor to obtain a form from his employer and then mail it, many times the donor may forget to obtain and/or mail the form after donating to a charity.

Furthermore, only a few multiple-charity sites exist that allow a donor to search for a favorite charity and donate to certain 501(c)(3) organizations. The multiple-charity sites offering this service usually use a third-party vendor such as GuideStar®, which operates a national database which includes more than 900,000 IRS-recognized U.S. non-profit organizations. For example, JustGive.org™ is a multiple-charity website that allows a donor to search the website and donate to any charity listed in GuideStar's® database. However, these multiple-charity sites do not offer a donor the options of convenient automatic recurring billing, automated gift matching, or automated loyalty point donation.

### SUMMARY OF INVENTION

The present invention includes an Automatic Bill Payment Enrollment system for recurring donations. The system links a Donation Portal to an enrollment site, thereby allowing members to automatically charge charitable donations on a recurring basis to the member's financial account which may be associated with a transaction card. For example, in one embodiment, the member may authorize and the system may implement a charge of $100 annually to a desired college and $20 annually to another charity such as Save the Children. Alternatively, the member may authorize a $100 charge to a desired college and a $20 monthly charge to a different charity.

In one embodiment, the invention uses the same database as the Donation Portal having various webpages such that the member may donate to virtually all U.S. 501 (c)(3) organizations for tax deduction purposes. In an alternative embodiment, a donor may donate to any other desired organizations in the U.S. The system may also incorporate various filters or donation analysis software to comply with government guidelines such as, for example, The Office of Foreign Assets Control (OFAC) which outlines requirements for restricting monies being sent to terrorist organizations.

The invention also includes a loyalty point donation system. In one embodiment, loyalty points may be donated from a donor to a charity, wherein the donated points are converted to a monetary value or goods and services, prior to donation to the charity. In an alternative embodiment, a charity may accumulate loyalty points from many donors, then redeem the points for goods or services at a later time.

In another exemplary embodiment, the invention also includes functionality to facilitate employee gift matching by providing an email to the donor to confirm the donation. In that regard, the system allows an employee to donate through the Donation Website and then submit its email receipt as documentation for an employer gift matching program. In various embodiments, the system may allow the employee to simply forward an email to its employer, allow the employee or employer to enter data into certain webpages, allow the employer to have certain access rights to verify donations by an employee, or allow reports to employers in any desired format or medium. The invention may then allow the employer to automatically contribute to the same charity through an employer matching program. The invention may also provide for automated donation verification with employers, whereby information related to employee donations are automatically forwarded to employers for verification purposes.

### BRIEF DESCRIPTION OF DRAWINGS

A more complete understanding of the present invention may be derived by referring to the detailed description and claims when considered in connection with the figures, where like reference numbers refer to similar elements throughout the figures, and:

FIG. 1 includes a block diagram illustrating an exemplary system of the present invention;

FIG. 2 includes a flowchart illustrating an exemplary method for completing a donation;

FIG. 3 includes a flowchart illustrating additional details of an exemplary method in accordance with the present invention; and

FIG. 4 includes a flow chart illustrating details of the gift matching method of the present invention.

### DETAILED DESCRIPTION

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method descriptions may be executed in any order and are not limited to the order presented.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system computing components discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, the computing systems may include an operating system (e.g., Windows NT, 95/98/2000, OS2, UNIX, Linux, Solaris, MacOS, etc.) as well as various conventional support software and drivers typically associated with computers. Donor computer may be in a home or business environment with access to a network. In an exemplary embodiment, access is through the Internet through a commercially-available web-browser software package. In an exemplary implementation, the donation system may be implemented as computer software modules loaded onto the donor computer and the charity computing system. However, the donor or charity computer may not require any additional software to participate in the online transactions.

As used herein, the term “network” shall include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, “Internet Standards and Protocols” (1998); “Java 2 Complete”, various authors, (Sybex 1999); Deborah Ray and Eric Ray, “Mastering HTML 4.0” (1997); and Loshin, “TCP/IP Clearly Explained” (1997), the contents of which are hereby incorporated by reference.

The various system components may be independently, separately or collectively suitably coupled to the network via data links which include, for example, a connection to an Internet Service Provider (ISP) over the local loop as is typically used in connection with standard modem communication, cable modem, Dish networks, ISDN, Digital Subscriber Line (DSL), or various wireless communication methods. See, e.g., Gilbert Held, “Understanding Data Communications” (1996), hereby incorporated by reference. It is noted that the network may be implemented as other types of networks, such as an interactive television (ITV) network. Moreover, the system contemplates the use, sale or distribution of any goods, services or information over any network having similar functionality described herein.

Various databases used herein may include, for example, donor data, charity data, financial institution data, and/or like data useful in the operation of the present invention. Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. In this regard, the data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a Block of Binary (BLOB). Thus, any binary information may be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first issuer, a second data set which may be stored may be provided by an unrelated second issuer, and yet a third data set which may be stored, may be provided by an third issuer unrelated to the first and second issuer. Each of these three exemplary data sets may contain different information that is stored using different data storage formats and/or techniques. Further, each data set may contain subsets of data which also may be distinct from other subsets.

As stated above, in various embodiments of the present invention, the data may be stored without regard to a common format. However, in one exemplary embodiment of the present invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, charity, issuer, donor or the like. Furthermore, the security information may restrict/permit only certain actions such as accessing, modifying, and/or deleting data sets. In one example, the data set annotation indicates that only the data set owner or the donor are permitted to delete a data set, various identified charities are permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one preferred embodiment, the header or trailer is not stored on the transaction device along with the associated issuer-owned data but instead the appropriate action may be taken by providing to the transaction instrument user at the stand alone device, the appropriate option for the action to be taken. However, the present invention contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Intervase, etc., may be used to provide an Active Data Object (ADO) compliant database management system.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service which receives a request from a browser which includes a URL (http://yahoo.com/stockquotes/ge) and an IP address (123.56.789). The web service retrieves the appropriate web pages and sends the web pages to the IP address.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components (e.g., memory elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

As used herein, the term “user”, “donor”, “end user”, “consumer”, “customer”, “cardmember”, “business” or “charity” may be used interchangeably with each other, and each shall mean any person, entity, machine, hardware, software or charity. A bank may be part of the system, but the bank may represent other types of card issuing institutions, such as credit card companies, card sponsoring companies, or third-party issuers under contract with financial institutions. It is further noted that other users may be involved in some phases of the transaction, such as an intermediary settlement institution, but these users are not shown.

Each donor is equipped with a computing device in order to interact with the system and facilitate online commerce transactions. The donor has a computing unit in the form of a personal computer, although other types of computing units may be used including laptops, notebooks, hand held computers, set-top boxes, cellular telephones, touch-tone telephones and the like. The charity has a computing unit implemented in the form of a computer-server, although other implementations are contemplated by the invention. The bank has a computing center shown as a main frame computer. However, the bank computing center may be implemented in other forms, such as a mini-computer, a PC server, a network of computers located in the same or different geographic locations, or the like. Moreover, the system contemplates the use, sale, donation or distribution of any goods, services or information over any network having similar functionality described herein.

The charity computer, bank computer and any other computer of the present invention may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions.

In general, the present invention discloses a donation engine that is configured to facilitate at least one of automatic recurring billing, access to a plurality of government approved charities, loyalty point donations and employee gift matching. In one embodiment, the donation engine allows a donor to search through a plurality of charities, select one or more of those charities, and then donate to those charities on a recurring billing basis, wherein the donation may include loyalty points and the donor may efficiently arrange employee gift matching.

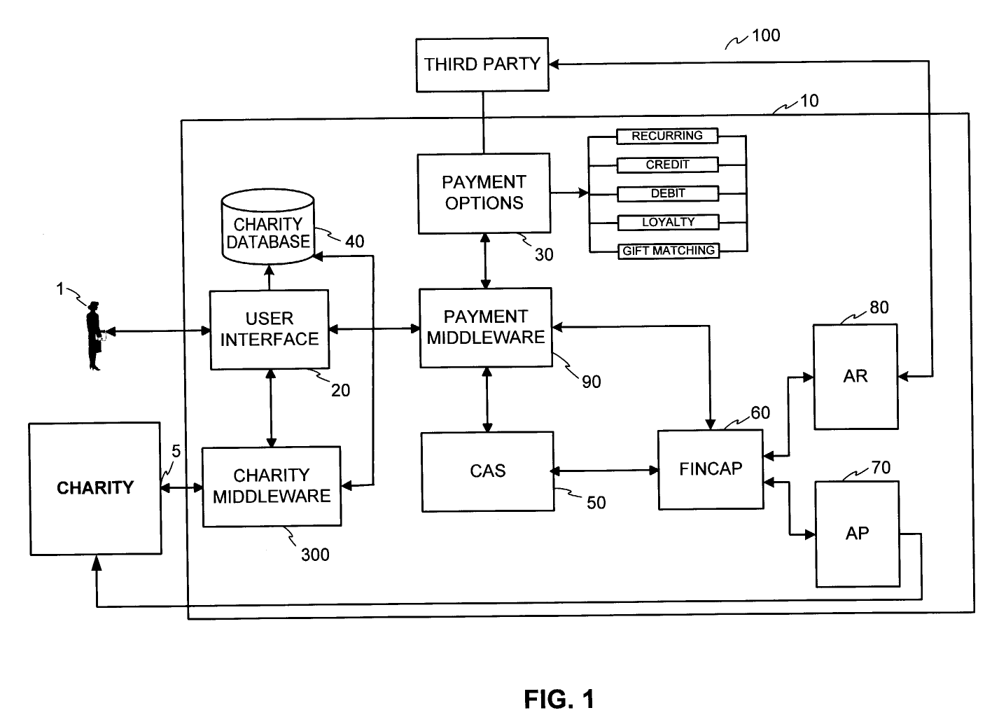

In an exemplary embodiment of the present invention, as illustrated in FIG. 1, a donation system facilitates a donor 1 accessing a donation engine 10 in order to give value to a charity 5. A system of the present invention may comprise various subsystems and applications, and in one embodiment, the system includes a User Interface System 20, a charity middleware 300, a charity database 40, payment options 30, payment middleware 90, a card authorization system (CAS) 50, a financial capture system (FINCAP) 60, accounts payable (AP) 70 and accounts receivable (AR) 80 systems. These exemplary components and systems of the present invention are described below in more detail.

Donor 1, as used herein, includes any individual, business, organization, entity, software, hardware and/or the like that desires to donate value to at least one charity. Donor 1 may also include any user, card holder, and/or card member.

Although this application refers to donor 1 giving value, it should be understood that value may include any type of monetary value or non-monetary donation having intrinsic or perceived value. The value may include money or loyalty points. Money may include, for example, bank notes, securities, stocks, credit, cash, and the like. Loyalty points may include, for example, coupons, frequent flyer miles, incentive awards, frequency awards, and the like. One example of loyalty points contemplated by this invention is the membership reward points awarded to donors who are members of the American Express Membership Rewards® program.

It should be further understood that, by giving value, donor 1 may be engaging in a transaction with a charity using donation engine 10 as an intermediary. The term “transaction” not only contemplates an exchange of goods or services for value from one party to another, but also the gifting of something of value from donor 1 to charity 5. This may be, for example, gifting of money from donor 1 to charity 5. Additionally, transaction or transaction card numbers may include account numbers that are used to facilitate any type of transaction. As used herein, a “transaction card” may include any account used for financial and/or value transactions wherein the account may or may not be associated with a physical card, such as a charge card, credit card, debit card, smart card, barcoded card, magnetic stripe card, account number, internet account, internet card, personal digital assistant account, digital wallet account, airline card, mall card, frequent shopper card, and/or the like. An “account” or “account number”, as used herein, may include any device, code, number, letter, symbol, digital certificate, smart chip, digital signal, analog signal, biometric or other identifier/indicia suitably configured to allow the donor to access, interact with or communicate with the system such as, for example, one or more of an authorization/access code, personal identification number (PIN), Internet code, other identification code, and/or the like, which may optionally be located on or associated with a rewards card, charge card, credit card, debit card, prepaid card, telephone card, smart card, magnetic stripe card, bar code card, transponder, radio frequency card or an associated account. The account number may be distributed and stored in any form of plastic, electronic, magnetic, radio frequency, wireless, audio and/or optical device capable of transmitting or downloading data from itself to a second device. A donor account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000”. The first five to seven digits are reserved for processing purposes and identify the issuing bank, card type, etc. In this example, the last (sixteenth) digit is used as a sum check for the sixteen-digit number. The intermediary eight-to-ten digits are used to uniquely identify the cardholder. A charity account number may be, for example, any number or alpha-numeric characters that identifies a particular charity for purposes of card acceptance, account reconciliation, reporting, or the like.

Charity 5 may be any charitable organization, individual, business, entity, political campaign, lobbying group, trade association, business league, chambers of commerce, software, hardware and/or the like that accepts value donations, whether or not in exchange for goods and services. For example, in one embodiment, charity 5 may be the Muscular Dystrophy Association. The charity 5 need not be affiliated or partnered with the donation engine.

Donation engine 10, as used herein, includes any software or hardware that is suitably configured to perform the methods of the present invention. It should be appreciated that although FIG. 1 depicts User Interface System 20, charity database 40, payment options 30, payment middleware 90, CAS 50, FINCAP 60, AP 70 and AR 80 as contained within one donation engine, it should be appreciated that donation engine 10 may comprise many subcomponents, subsystems and/or access variety of other systems. While a closed-loop network may contain many, if not all of the subsystems in FIG. 1, an open network system may utilize various acquirer and issuer networks and components that make up the various systems in FIG. 1. One skilled in the art will appreciate that these systems may be one system, distributed systems or any other arrangement of systems in any form, such as software, hardware, etc. Further, the various subsystems described herein may be contained within one donation engine 10 or within many donation engines 10.

In addition to the systems and methods of communication previously discussed, the communication among donor 1, charity 5, donation engine 10 or additional third parties (as may be contemplated by various embodiments) may take place over any computerized network via any suitable user interface system 20 that allow for the exchange of analog or digital information. As such, these systems may include, for example, telephone interactive voice response or operator-facilitated systems, online or offline computer networked systems using various transfer protocols, wireless devices, personal data assistants, interactive TV, broadband, ultrawide band devices, transponders and the like. For example, the user interface system may comprise web servers and applications configured to facilitate client/server communication over the internet via any wireless or wire-based system.

Charity database 40 may include any hardware, software or database configuration discussed herein, suitably configured to store information, links or web pages related to charities. Charity database 40 may be a database including information related to one or more individual, entity, government approved charities or the like. In one embodiment, the database may include or have access to all government approved charities. The charities may include 501 (c)(3) organizations. 501 (c)(3) organizations are charities or philanthropies that have obtained a not-for-profit status through documentation by the Internal Revenue Service. To obtain IRS approval, 501 (c)(3) organizations must have purposes that are charitable, educational, religious, scientific, literary, supporting national or international amateur sports, supporting the prevention of cruelty to children or animals, and/or supporting testing related to public safety. An example of a 501 (c)(3) organization is the Muscular Dystrophy Association. Charity database 40 may also comprise databases of any charitable organizations, individuals, businesses, political campaigns, lobbying groups, trade associations, business leagues, chambers of commerce, and the like. For example, charity database 40 may also comprise databases of any 501 (c) and/or 509 (a) organizations. Further, charity database 40 may also obtain information from a third-party database vendor such as GuideStar®, which maintains a national database of 501 (c)(3) charities. Charity database 40 may maintain its database of 501 (c)(3) or other organizations by continuously, randomly or periodically downloading new or updated information to database 40 from a government list, such as those listed in IRS Publication 78, Cumulative List of Organizations. Information may also be downloaded and/or updated in real-time or on a batch basis, where downloading and/or updating recurs on a daily, weekly, monthly, and/or other time period.

Charity middleware 300 is any hardware and/or software that is generally configured to facilitate communication between charity 5 and charity database 40. Charity middleware 300 may be configured to provide charity 5 with capabilities to interface with charity database 40 including, for example, listing and adding charity information, deleting charity information, and/or updating financial information. Charity 5 may access charity middleware 300, as depicted in an exemplary embodiment in FIG. 1. Charity 5 may also access charity middleware 300 via user interface 20 or via any other user interface, network or communication device discussed herein. Access may be controlled by any security features or levels of access limitations discussed herein including, for example, a PIN, password, and/or any other known security features for accessing/updating database information. Charity middleware 300 may be configured to directly communicate with charity database 40 such that any updates into charity middleware 300 are simultaneously updated into charity database 40. Charity middleware 300 may also be configured to allow for batch updating of information into charity database 40.While charity middleware 300 and charity database 40 are configured as two separate components in FIG. 1, charity middleware 300 and charity database 40 may also be configured to embody a single component.

Payment options component 30 may be any software and/or hardware suitably configured for managing, tracking, and/or reporting payment information. Payment information may include credit card information, debit card information, recurring billing information, loyalty point information, gift matching information and/or the like. Payment options 30, as contemplated by the present invention, may be a stand-alone system or may be affiliated or integrated with other payment methods or networks, examples of which are disclosed herein. The component parts of exemplary payment options 30 generally include a server and database systems for processing and storing payment information. As depicted in FIG. 1, payment options 30 may exist within donation engine 10. Alternatively, payment options 30 may be a separate payment system and method accessed by donation engine and/or managed by a third party.

Payment middleware 90 is any hardware and/or software that is suitably configured to facilitate communication between payment options 30, existing transaction card processing systems, and/or redemption networks. Specifically, payment middleware 90 is configured to, inter alia, (1) receive requests relating to different value methods as currency, via a user interface system 20, (2) verify with payment options 30 that sufficient value of the selected type is available, (3) communicate with CAS 50 to determine if donor's 1 financial transaction account is active and has a sufficient credit limit, (4) convert selected value to currency, and (5) interact with FINCAP 60 or AR 80 systems in order to credit a donor's financial transaction account with the appropriate amount of value. Payment middleware 90 may comprise various servers, databases, routers, relays and the like in order to suitably process, route, and transmit data among, inter alia, user interface system 20, payment options 30, FINCAP 60, and CAS 50.

CAS 50, FINCAP 60, AP 70 and AR 80 represent systems employed by transaction card companies like American Express® and other card acquirers or card issuers to authorize merchant transaction requests and process settlement requests. While FIG. 1 shows these systems in a single donation engine 10, it should be appreciated that these systems take various forms depending on the particular donation engine or groups of donation engines. For example, exemplary CAS 50 receives an authorization request from payment middleware 90 to determine if the financial transaction account associated with a transaction card number is valid and has sufficient credit. CAS 50 includes systems for comparing the transaction details (e.g., account number, monetary amount of transaction, expiration date, etc.) with donor's 1 financial transaction account information to determine if the financial transaction account is active and if a sufficient credit limit exists to complete a transaction. If these conditions are satisfied, CAS 50 returns to FINCAP 60 an approval code reflecting that FINCAP 60 is authorized to complete the transaction. Payment middleware 90 or payment options 30 may also either reference this same CAS 50 as shown in FIG. 1 to determine if donor's 1 account information is valid (and with sufficient value) or may invoke a separate CAS component (not shown) to complete the same task.

The approval code includes a record of charges (ROC) and summary of charges (SOC). The ROC file generally contains transaction details which could include inter alia, an identifier for charity 5, amount of donation, date of donation, recurring billing information, and/or expiration date. This information is captured in FINCAP 60 where it is processed for charity 5 payment and donor 1 billing. FINCAP 60 then sends a payment file to AP 70 to pay charity 5, retrieves the appropriate donor 1 (e.g., cardholder) account information, and sends a billing file to AR 80. In an exemplary embodiment, donor 1 has a transaction card associated with a financial transaction account (e.g., Discovers card, American Express card, etc.), wherein the card provider is what is referred to herein as the financial transaction institution. AR 80 generates a billing statement to send to donor's 1 financial transaction institution that reflects the appropriate billing information such as date of charge, amount of charge, charity, recurring rate, if any, etc.

In one embodiment, AR 80 receives a credit from payment middleware 90 to appropriately offset at least a part of a financial transaction institution transaction charge. Alternatively, as shown in FIG. 1, payment middleware may send credit requests to FINCAP 60 for processing and forwarding to AR 80. The payment file sent to AP 70 may be processed immediately or in the near future. For example, when donor's 1 donation and payment information is processed, a payment file is generated and sent to AP 70. The payment file includes the amount of donation, the name of charity 5, payment address for charity 5, and any other relevant payment details. AP 70 then generates a payment form and transmits it to charity 5. The payment form may be in the form of a check, cash, electronic distribution, or any other payment method. AP 70 may transmit to charity 5 through the mail, a courier, electronic means, or any other method of sending a payment for receipt by charity 5.

Engine 10 may also be configured to facilitate payment to charities on a recurring basis (e.g., weekly, monthly, yearly). For example, engine 10 may store multiple donations to charity 5 over a monthly time-period in AP 70. At the end of the monthly time-period, AP 70 may generate and transmit a lump payment form consisting of all the individual donations to charity 5 over the time-period. This configuration may reduce costs by reducing mailings and payment processing time.

Engine 10 may also be configured to provide for certification of each charity awaiting payment in AP 70. By providing for certification, engine 10 may communicate with one or more third parties or databases (e.g., the IRS database of 501 (c)(3) organizations) and compare database entries to ensure that each charity is in fact government approved.

In an exemplary system, donor's 1 financial transaction institution may be both a card provider and a loyalty program provider. Registration and enrollment processes are known in the art, and as such, will not be discussed in depth herein. Although an exemplary embodiment contemplates the use of, and integration of a participant's loyalty account and financial transaction account, other embodiments (e.g., a secondary or proxy transaction number embodiment, stored value card, gift certificate, etc (discussed later)) may not necessarily require this integration.

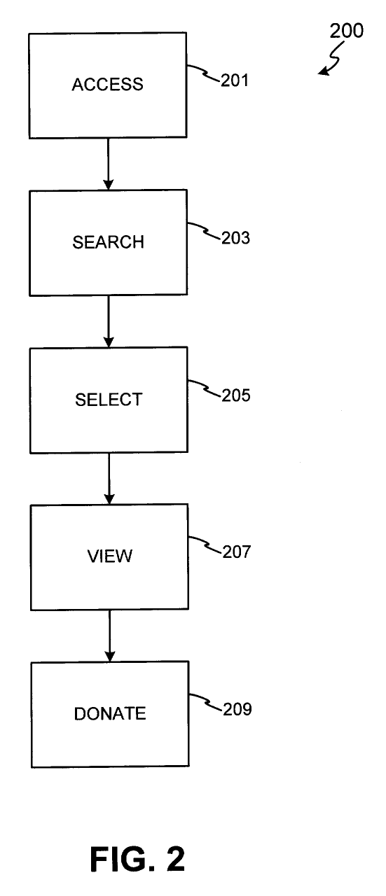

The donation method may be facilitated using an integrated or stand-alone system. An exemplary online donation method is depicted in FIG. 2. With additional reference to FIG. 1, exemplary donation method utilizes user interface system 20 suitably configured with an appropriate web server system to facilitate online transactions. User interface system 20 may be configured to facilitate donor 1 in accessing (step 201) charity database 40. Access may be provided by way of automatic presentment of a graphical interface employing selectable links. Access may also be provided via a password, login, PIN or any other secure means for access known in the art.

Charity database 40 may be configured to facilitate donor 1 in searching (step 203) for a charity. Donor 1 may search in a variety of ways, including searching by charity name, charity category, state, city, and/or income range. If there are no charities in charity database 40 matching donor's 1 search criteria, charity database 40 may report this fact in a message to donor 1. After searching for charities, charity database 40 may present the search results on a different web page. With reference again to an exemplary embodiment depicted in FIG. 2, donor 1 may select (step 205) at least one charity. By selecting, donor 1 may click on a charity, highlight the charity and press a selection key, and/or use any other method known in the art for selecting an object. By selecting, the charity may be added to a cart or a basket for later donating and processing. As part of the selection process, engine 10 may certify that the selected charity is a government approved charity. To certify, engine 10 may communicate with one or more third parties or databases (e.g., the IRS database of 501 (c)(3) organizations) to ensure that the charity is on a list of government approved charities.

After selecting a charity, donor 1 may view or link to (step 207) additional charity information, including, for example, a mission statement, programming information, financial information, a web-site address, personnel information, and/or contact information. Donor 1 may also select an option to donate (step 209) to the selected charity or to select additional charities to receive donations. Once donor 1 selects to donate to one or more charities, with reference again to FIG. 1, payment middleware 90 may process the donation as previously discussed. While FIG. 2 depicts steps 201-209 in a specific order, accessing, searching, selecting, viewing and donating may be achieved in any order.

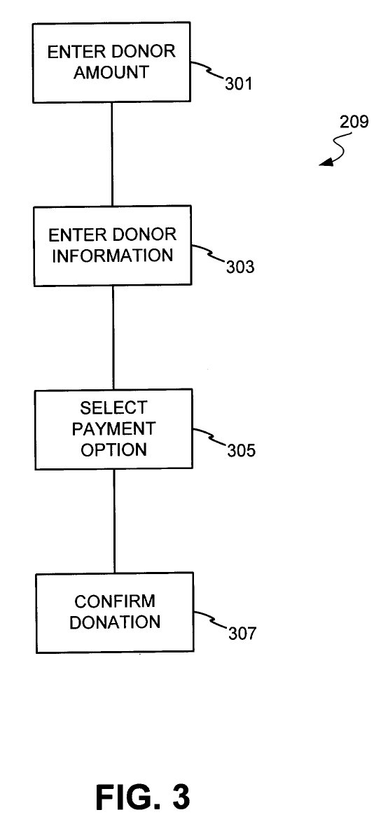

In an exemplary embodiment depicted in FIG. 3, payment middleware 90 may process a donation. Donor 1 may enter a donation amount (step 301) and/or donor information (303). A donation amount may comprise any value amount, or a donation amount may meet a minimum standard (e.g., at least $5). Donor information may include a variety of information about donor 1 including, for example, name, mailing address, billing address, email address, and phone number. Donor information may also include an option for designation of a donation (e.g., the donation may be in honor of, or a gift to, a third party.)

After entering in donor information, donor 1 may select a payment option (step 305). Payment options may include, for example with reference again to FIG. 1, credit card, debit card, recurring billing options, loyalty points, and/or employer gift matching. Third-party transaction institution 100 may be used to process and/or verify any of the selected payment options, as discussed herein. These payment options will now be discussed in more detail.

By selecting payment by credit card, donor 1 may pay by any transaction card associated with a financial transaction account (e.g., Discover® card, American Express® card, etc.). By selecting payment by debit card, donor 1 may pay with any check/debit card which deducts money directly from donor's 1 checking or savings account. A debit card may include bank check cards as well as debit cards affiliated with Visa® or other financial institutions. By using a debit card, the system may request a PIN and/ or bank account information from the donor in order to process the payment. Engine 10 may be configured to facilitate payment by credit card or payment by debit card by use of a third-party institution 100 such as VeriSign®. VeriSign®, for example, helps ensure secure payments for online commerce. Verification of donor 1 card information may involve communication with CAS 50, FINCAP 60, AP 70, AR 80 and/or one or more third-party financial institutions. Processing of a transaction may be by any method known in the art and/or may be consistent with methods discussed herein.

Donor 1 may also select to pay by recurring billing. Recurring billing may be configured to facilitate donor 1 paying on a recurring basis (e.g., monthly, quarterly, annually). Recurring billing may also be combined with payment by credit card or by debit card to allow for a payment amount to be automatically deducted from donor's 1 card on a recurring basis (e.g., $10 is deducted from donor's credit card each month). The system may also send a recurring bill to the donor for the donor to submit payment. Engine 10 may be configured to facilitate recurring billing by a third-party institution 100 such as VeriSign®.

With reference again to FIG. 1, payment options 30 may also be configured to facilitate payment by use of loyalty points. For example, donor 1 may select to pay by loyalty points and then search loyalty point issuers by using any search engine known in the art or by searching through a list of known loyalty point issuers contained within donation engine 10. Loyalty point issuers may comprise any inside vendor and/or third-party vendor that operates a program in which a member may earn loyalty points (e.g., points, miles, etc.) that may be redeemed for value. Donor 1 may select a participating loyalty point issuer in order facilitate the redemption of donor's 1 loyalty points. For example, donor 1 may select to redeem membership rewards points earned through the American Express Membership Rewards® program and then apply these points towards the donation to the selected charity. The system may communicate with the loyalty point issuer and/or by any other loyalty point verifier to verify and/or deduct the loyalty points. The loyalty points may also be converted into currency and/or other value by the loyalty point issuer, by another third party, by the donation engine 10 or payment middleware 90. Verification and conversion of loyalty points may be by any method known in the art.

With reference again to FIG. 1, payment options 30 may also be configured to facilitate gift matching by donor's employer by providing a gift matching 450 option. Gift matching may be configured to only activate after donor 1 processes a payment by credit card, debit card, and/or loyalty point redemption. For example, after donor 1 selects to donate by redeeming loyalty points, donor 1 may select for his employer to match that donation. When donor 1 selects gift matching, payment middleware 90 may generate and transmit an instant email and/or digital receipt to facilitate employee gift matching. The digital receipt may be printed out and/or saved. The digital receipt may also be transmitted to any recipient including, but not limited to the employee, the charity, the employer, and/or the third-party transaction institution. For example, in one aspect of the present invention, employee/donor 1 may select to donate to charity 5 by payment by credit card. Once employee/donor 1's credit card transaction is processed, gift matching may be selected.

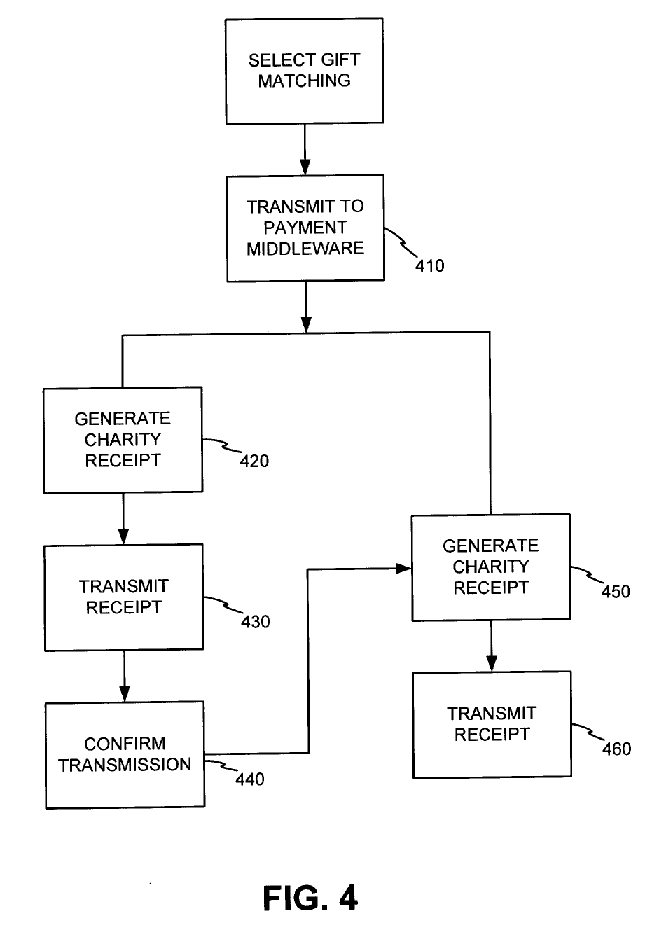

The system may allow employees to simply forward emails to their employers, to enter gift matching data into certain web pages, to provide employers with certain access rights to verify donations by employees, and/or to generate reports for employers in any desired format or medium which provide donation information regarding certain employees or groups of people. The system may be configured to allow the employer to automatically contribute to the same charity through an employer matching program. The system may also be configured to provide for automated donation verification with employers, where employee donations are automatically forwarded to employers for verification purposes. For example, with reference to exemplary embodiments depicted in FIG. 4 and FIG. 1, donor 1 may select a gift matching option from payment options 30. As part of this selection, donor 1 may enter in gift matching information including, for example, donation amount, donor 1 employer information, and/or charity 5 information. After donor 1 enters this information, engine 10 may be configured to automatically transmit this information to payment middleware 90 (step 410). Payment middleware 90 may be configured to facilitate the transaction by generating two receipts for the donation (steps 420, 450). A first receipt may contain donation information including, but not limited to: donor 1 information, donation amount, and/or charity 5 information. The first receipt may then be transmitted (step 430) to charity 5. The receipt may be an electronic receipt and/or a paper receipt. Transmission of the receipt may be by electronic means (e.g., email) as well as by non-electronic means (e.g., mail), such that the information is sent from payment middleware 90 for receipt by charity 5. A confirmation may be generated (step 440) after transmission to charity 5 is completed. The confirmation may include verification of donor's 1 donation to charity 5.

A second receipt may also be generated (step 450) by payment middleware 90. By generating the second receipt, payment middleware may be configured to search a database of employer-specific gift matching forms and generate a form that corresponds to a particular charity 5. The receipt may be configured to include the gift matching form. The receipt may also include, for example, donor 1 information, donation amount, charity 5 information, a thank you to the employer for gift-matching and/or a confirmation, where the confirmation may be the same as the confirmation generated in step 440. The receipt may then be transmitted (step 460) to employer 200. The receipt may be an electronic receipt and/or a paper receipt. Transmission of the receipt may be by electronic means (e.g., email, fax, data download) as well as by non-electronic means (e.g., mail), such that the information is sent from payment middleware 90 for receipt by employer 200. Upon receiving the receipt, employer 200 may use the information in the receipt, including the gift matching-form to process the gift-matching. The receipt information may also be automatically downloaded into the employer's database or accounting system for more efficient processing and record-keeping. By processing the gift-matching, employer 200 may transmit value to charity 5 in an amount that corresponds to the employer's 200 gift-matching policies.

Alternatively, engine 10 may be configured to facilitate automated gift matching. In this alternative embodiment, engine 10 may contain a database that contains information on the specific gift matching criteria for each employer in the database. For example, employer 200 may approve 100% gift-matching for all employee donations to the Muscular Dystrophy Association (MDA), 50% gift-matching to colleges and no gift matching for religious organizations. This information may be stored in a database within engine 10. Thus, employee/donor 1 may select to donate and gift-match to the MDA. Once donor 1 enters employer 200 information or code as his employer, engine 10 may automatically generate and transmit a payment file in the name of employer 200 in AP 70. The payment file may contain the same amount as donor 1 previously entered. Prior to, upon or after receipt of payment from employer, engine 10 may then pay charity 5 via the payment file in AP 70.

Once donor 1 enters employer 200 as his employer, engine 10 may also automatically generate and transmit a billing statement in the name of employer 200 in AR 80. The billing statement reflects the appropriate billing information such as date of charge, amount of charge, charity, recurring rate, if any, etc. for employer 200 to pay. Engine 10 may then bill employer 200 via the billing statement in AR 80. The donation information and amount in the billing statement will equate to the donor-specific gift-matching program. For example, with respect to the previous MDA example, the donation amount billed to employer 200 will be 100% the amount that donor 1 previously entered. The system may also convert the employee donated amount to the amount previously agreed upon as a donation by the employer. In the example above, if the employee donated $100 to each charity, the system may send an invoice to employer for $100 to MDA, and $50 to the chosen college. The automated gift matching feature may also be configured to facilitate capped-giving amounts. That is, if employer 200 gift matches only up to $250, this information may be stored in engine 10 and processed accordingly. The automated gift matching feature may be configured to facilitate recurring employer 200 gift matching to correspond to donor 1 recurring billing. The automated gift matching feature may also be configured to facilitate automatic updating of employer 200 donation information corresponding to modification of donor 1 donation information. Thus, if donor 1 decides to stop a recurring donation, engine 10 will automatically stop the recurring gift-matching.

After selecting and processing payment options, donor 1 may also be presented with an option of confirming (step 307) the donor amount, information, and payment option information before payment middleware 90 sends the payment information to CAS 50 or FINCAP 60. The confirming step may also include an option to link to various terms and conditions, for example, terms and conditions relating to the donation process, recurring billing, loyalty point information, and/or gift matching information. Donor 1 may be asked to submit to and agree to certain terms and conditions as part of the confirmation process. Upon confirmation, donor 1 may be presented with a thank you page. The thank you page may contain detailed payment information and/or tax information for donor 1 to print out for his records. Additionally, payment middleware 90 may be configured to generate a confirmation email. This confirmation email may comprise a standard email receipt with a list of donor's 1 designated charities for non-recurring billing donations. The confirmation email may also comprise a custom email tailored for recurring billing donations.

For more information on loyalty systems, transaction systems, donation systems and digital wallet systems, see, for example, U.S. patent application Ser. No. 09/836,213, filed on Apr. 17, 2001, by inventors Voltmer, et al., and entitled “System And Method For Networked Loyalty Program”; U.S. Continuation-In-Part patent application Ser. No. 10/027,984, filed on Dec. 20, 2001, by inventors Ariff, et al., and entitled “System And Method For Networked Loyalty Program”; U.S. Continuation-In-Part patent application Ser. No. 10/010,947, filed on Nov. 6, 2001, by inventors Haines, et al., and entitled “System And Method For Networked Loyalty Program”; the Shop AMEX™ system disclosed in U.S. Patent Application Ser. No. 60/230,190, filed Sep. 5, 2000; the MR as Currency™ and Loyalty Rewards Systems disclosed in U.S. Patent Application Ser. No. 60/197,296, filed on Apr. 14, 2000; U.S. Patent Application Ser. No. 60/200,492, filed Apr. 28, 2000; U.S. Patent Application Ser. No. 60/201,114, filed May 2, 2000; the digital wallet system disclosed in U.S. patent application Ser. No. 09/652,899, filed Aug. 31, 2000; the stored value card disclosed in U.S. patent application Ser. No. 09/241,188, filed Feb. 1, 1999; the system for facilitating transactions using secondary transaction numbers disclosed in U.S. patent application Ser. No. 09/800,461 filed, Mar. 7, 2001; and also in related U.S. Provisional Patent Application Ser. No. 60/187,620, filed Mar. 7, 2000; U.S. Provisional Patent Application Ser. No. 60/200,625, filed Apr. 28, 2000; and U.S. Provisional Patent Application Ser. No. 60/213,323, filed May 22, 2000; all of which are herein incorporated by reference. Other examples of online membership reward systems are disclosed in Netcentives, U.S. Pat. No. 5,774,870, issued on Jun. 30, 1998, and U.S. Pat. No. 6,009,412, issued on Dec. 29, 1999, both of which are hereby incorporated by reference.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

1. A donation engine which is configured to facilitate:
providing access to a plurality of government approved charities;
searching for at least one of said charities; and
receiving donation information including recurring billing information, donor information, and donation amount.

2. The engine of claim 1 wherein said donation engine is located in an online environment.

3. The engine of claim 1 wherein said donation information further includes loyalty point donation information.

4. The engine of claim 1 wherein said donation information further includes gift matching information.

5. The engine of claim 1, wherein said providing access to a plurality of government approved charities includes providing access to all government approved 501(c) charities.

6. The engine of claim 1, wherein said providing access to a plurality of government approved charities includes providing access to all government approved 501(c) charities via a donation portal.

7. A donation method, said method comprising:
accessing an online donation portal, wherein said donation portal is configured to provide access to a plurality of government approved charities;
searching for at least one of said charities using a search function of said donation portal; and,
entering donation information into said donation portal, wherein donation information includes recurring billing information, donor information, and donation amount.

8. The method of claim 7 wherein said donation information further includes loyalty point donation information.

9. The method of claim 7 wherein said donation information further includes gift matching information.

10. A donation method, said method comprising:
accessing at least one of a plurality of accessible government approved charities;
receiving donation information for at least one of said charities, wherein donation information includes loyalty point information, donor information, and donation amount; and
verifying said loyalty point information.

11. The method of claim 10 wherein said receiving donation information further includes receiving recurring billing information.

12. The method of claim 10 wherein said receiving donation information further includes receiving gift matching information.

13. The method of claim 10, wherein said accessing at least one of a plurality of accessible government approved charities includes accessing at least one of all government approved 501(c) charities.

14. The method of claim 10, wherein said accessing at least one of a plurality of accessible government approved charities includes accessing at least one of all government approved 501(c) charities via a donation portal.

15. The method of claim 10, wherein verifying loyalty point information includes communicating with at least one third party, said third party including at least one of a financial institution, a charity, a loyalty point issuer, and a government entity authorized to approve charities.

16. An online donation method, said method comprising:
accessing at least one of a plurality of accessible government approved charities;
receiving donation information for at least one of said charities, wherein said donation information includes gift matching information, donor information, and donation amount; and
verifying said gift matching information.

17. The method of claim 16 wherein said donation information includes loyalty point donation information.

18. The method of claim 16 wherein said donation information further includes recurring billing information.

19. The method of claim 16 wherein accessing includes providing at least one of listing capabilities, searching capabilities and selecting capabilities.

20. The method of claim 16 wherein verifying gift matching information includes communicating with at least one third party, said third party including at least one of an employer, a financial institution, and the Internal Revenue Service.
